(19) United States
(12) Patent Application Publication
(10) Pub. No.: US 2015/0000630 A1
(43) Pub. Date: Jan. 1, 2015

(54) Rapid LNG Engine Warm-Up Utilizing Engine Compression Brakes

(71) Applicant: Caterpillar Inc., Peoria, IL (US)

(72) Inventor: Dana Ray Coldren, Secor, IL (US)

(21) Appl. No.: 13/927,952

(22) Filed: Jun. 26, 2013

(51) Int. Cl. F02D 41/00

(52) U.S. Cl. CPC F02D 41/0087; F02D 41/0025
USPC 123/304

(57) ABSTRACT

A system and method of utilizing engine compression braking technology to create a parasitic load on an engine during initial idling by putting some of the engine cylinders in braking mode while others remain in power mode. Engine compression brakes are operably connected to the engine cylinders. When engine temperature is below a predetermined value, the engine compression brakes for a portion of the cylinders are activated, and those cylinders impose a parasitic load on the engine that rapidly warms the engine.

### TECHNICAL FIELD

This disclosure relates generally to dual fuel engines in which one of the fuels is liquefied natural gas (LNG). More particularly, this disclosure relates to a system and method for rapidly warming up an LNG engine utilizing engine compression brakes.

### BACKGROUND

In a diesel fuel internal combustion engine, air is introduced into each combustion chamber (cylinder) during an air intake stroke and then compressed during a compression stroke. The compression increases the air temperature so that when diesel fuel is introduced into the cylinder at or near the top of the compression stroke the diesel fuel vaporizes and ignites in a process called compression ignition. The ignited fuel undergoes rapid expansion, driving the piston downward during the power stroke. Exhaust gases are expelled during an exhaust stroke and the four-stroke diesel “power cycle” begins again.

Diesel fuel engines enjoy high reliability, primarily due to the absence of the electrical ignition system required by their gasoline powered counterparts, and generally better fuel economy than gasoline powered engines. However, in recent years natural gas has become a desirable fuel source for internal combustion engines due to its lower cost and significantly lower emissions. Large diesel engines can be converted to run on natural gas with diesel fuel as a pilot (ignition) fuel. These “dual fuel” engines require onboard natural gas and diesel fuel (dual fuel) delivery systems.

The natural gas may be stored onboard in a pressurized temperature controlled tank as liquefied natural gas, or LNG. The natural gas is introduced by a fuel injector into the combustion chamber, where the natural gas is ignited by the separate injection of diesel fuel by the same “dual fuel” injector or by a separate injector.

High pressure direct injection (HPDI) is a dual fuel technology in which natural gas at high pressure is introduced directly into the combustion chamber of a dual fuel engine. In an HPDI engine, special HPDI injectors are used which allow for both natural gas and diesel fuel to be injected directly into the combustion chamber. A small amount of diesel fuel may be used as the ignition source to ignite the natural gas in the engine cylinder.

Traditionally, when LNG is used to power a dual fuel engine, especially a direct injection dual fuel engine in which the diesel fuel is ignited under high pressure, the engine coolant or exhaust gas are used to warm up the LNG from a liquid to a supercritical gas. This requires the engine to operate in diesel fuel only mode (DoM) after initial start-up until the engine coolant or exhaust gas warms up the LNG to the proper temperature. In order to maximize diesel substitution rates on the engine, it is desirable to minimize the warm-up time and begin gasifying the LNG quickly to allow the engine to begin burning natural gas (NG) instead of diesel fuel.

Similarly, when a dual fuel engine is idling in a very cold environment, it may be desirable to switch the engine cylinders to a parasitic power mode to make sure that the engine stays warm enough to warm up the LNG from a liquid to a supercritical gas.

The present disclosure is directed toward a system and method for achieving this objective.

### SUMMARY OF THE DISCLOSURE

The disclosure relates to a system and method of utilizing engine compression braking technology to create a parasitic load on an engine when desired, such as during initial idling or cold weather idling, by putting some of the engine cylinders in braking mode while others remain in power mode. Engine compression brakes are operably connected to one or more of the engine cylinders. When engine temperature is below a predetermined value, the engine compression brakes for a portion of the cylinders are activated, and those cylinders impose a parasitic load on the engine that rapidly warms the engine or maintains a warm engine temperature.

In one aspect of the disclosure, a system for rapidly warming up a dual fuel engine is provided. The rapid warm-up system comprises a dual fuel engine having a plurality of cylinders, an electronically controlled high pressure direct injector operably attached to each cylinder, an electronically controlled engine compression brake operably attached to at least one and preferably all of the cylinders, a sensor for sensing the temperature of the engine, and an electronic control module. The sensor may be adapted to sense engine coolant temperature, engine exhaust temperature, engine oil temperature or any other suitable temperature.

The electronically controlled high pressure direct injectors are operably attached to each cylinder and may be configured to deliver diesel fuel and natural gas to the cylinders. The high pressure direct injectors may be configured to deliver additional diesel fuel to the first portion of cylinders during rapid warm-up mode.

The electronic control module is in control communication with each high pressure direct injector, and includes a rapid warm-up mode in which the high pressure direct injectors for a first portion of the cylinders are activated and the engine compression brakes for a second portion of the cylinders are activated.

The first portion of cylinders (power cylinders) and the second portion of cylinders (braking cylinders) preferably equals the total number of cylinders. The power cylinders may change to braking cylinders and the braking cylinders change to power cylinders after a single engine cycle or after given number of engine cycles.

In another aspect of the disclosure a method for rapidly warming up a dual fuel engine having a plurality of cylinders is provided. The method may comprise the steps of:

Step 100: Determining an engine temperature, such as engine coolant temperature, engine exhaust temperature, engine oil temperature or any other suitable temperature.

Step 102: If the engine temperature is below a predetermined temperature, operating a first portion of the cylinders in a power mode during each engine cycle. This step may include injecting diesel fuel into the first portion of the cylinders using high pressure direct injectors.

Step 104: Applying a parasitic load to the engine. This step may include operating a second portion of the cylinders in braking mode during the same engine cycle.

The method may include the further step of:

Step 106: Changing which of the cylinders are operating in power mode and which cylinders are operating in braking mode. For example, this step may include changing the operating mode of every cylinder after a single engine cycle or after a given number of engine cycles. Alternatively, this step may include changing the operating mode of the cylinders on a rolling basis, wherein after a given number of cycles the operating mode of some cylinders change while the operating mode of other cylinders do not change.

In another aspect of the disclosure an electronically controlled delivery system operably attached to each cylinder is provided, the delivery system configured to deliver diesel fuel and natural gas to the cylinders. The delivery system may deliver high to medium pressure supercritical natural gas or low pressure natural gas to the cylinders via in-cylinder injection, port injection or fumigation into an air stream. Regardless of the NG delivery system, a natural gas/air mixture is ignited via the compression ignition of diesel fuel that has been injected into the cylinders.

### BRIEF DESCRIPTION OF THE DRAWINGS

FIG. 1 is a schematic diagram of an engine such as might be equipped with a rapid warm-up system according to the present disclosure;

FIGS. 2A to 2D are schematic diagrams of an engine cylinder 14 during a four stroke power cycle.

FIGS. 3A to 3D are schematic diagrams of an engine cylinder 14 during a four stroke braking cycle; and

FIG. 4 is a schematic diagram of a process for rapid engine warm-up according to the present disclosure.

### DETAILED DESCRIPTION

While this disclosure may be embodied in many forms, there is shown in the drawings and will herein be described in detail one or more embodiments with the understanding that this disclosure is to be considered an exemplification of the principles of the disclosure and is not intended to limit the disclosure to the illustrated embodiments.

For example, although the following discussion refers to an engine in which the injection of both diesel fuel and natural gas into each engine cylinder is accomplished by a single high pressure dual-fuel injector, it should be understood that the disclosure also contemplates an engine in which diesel fuel and natural gas are injected into each cylinder by separate injectors.

The present disclosure relates to a system and method of rapidly warming up a dual fuel engine utilizing engine compression braking and cylinder cutout technology. The engine compression braking technology increases the load on the engine after initial start-up which accelerates the warm-up process. The system and method may be used during initial engine warm-up to warm the engine quickly, and can be used to keep the engine warm during idle conditions in very cold climates.

### Background

Engine compression braking was originally developed as an alternative way to slow down large tractor-trailers without causing wear and tear on the wheel brakes. In a typical four-stroke diesel engine, as the pistons move upward air is compressed in each cylinder, which superheats the air. At or near the point of greatest compression diesel fuel is introduced into the superheated air and immediately begins burning, pushing the cylinder downward. After this power stroke, the cylinder again moves upward, this time while the exhaust gas valve is open, forcing out the exhaust gases. The next down stroke causes the cylinder to be refilled with air.

This four stroke process changes with engine compression braking. When engine compression braking is activated, after the initial air compression stroke at the point of greatest air compression, the exhaust valve opens, allowing the heat from the superheated air to be released through the exhaust system. This slows down the vehicle and saves wear on the wheel brakes. The cylinders in which the engine compression technology is used are referred to as being in “braking mode.”

In a typical dual fuel engine without the present technology, the engine operates in diesel fuel only mode (DoM) after initial start-up until the engine coolant or exhaust gas temperature is high enough to warm the LNG to a supercritical gas phase suitable for use as fuel. The parasitic loads on the engine after initial start-up typically are limited to such things as fans, belts, water pumps and fuel pumps. These loads don't generate much engine heat and so the warm-up time during which diesel fuel is being burned can be long. Increasing the load on the engine increases the amount of fuel being burned, which raises the engine temperature and the exhaust gas heat. The present disclosure relates to a system and method for rapidly warming up a dual fuel engine using engine compression braking technology in order to more quickly convert the engine over to natural gas combustion.

### The Rapid Warm-Up System

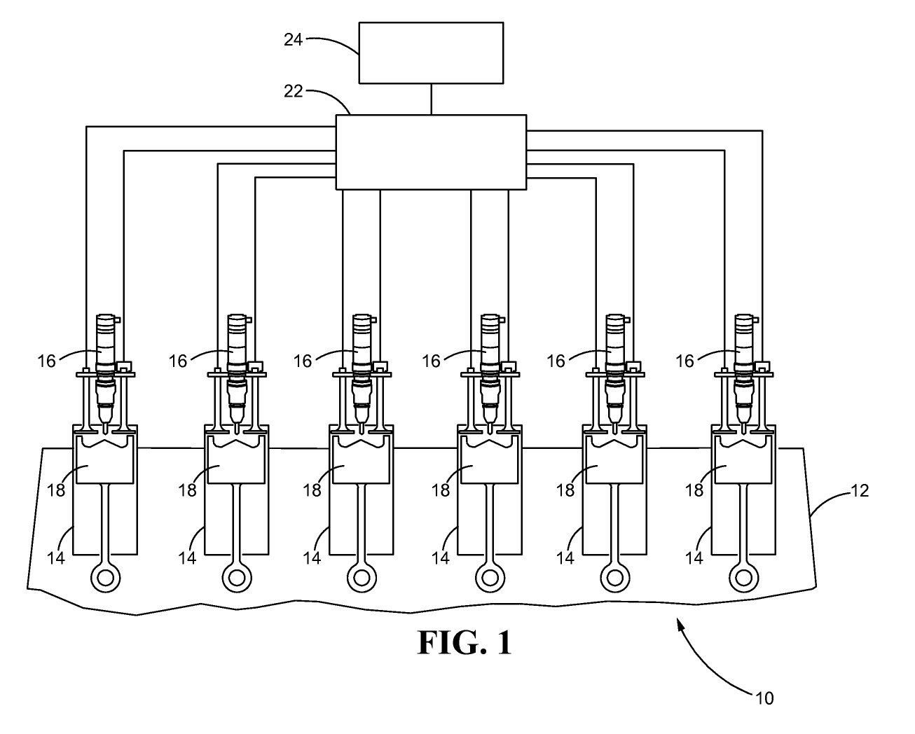

Turning to the drawings, there is shown in FIG. 1 a schematic diagram of an engine 10 such as might be equipped with a rapid warm-up system according to the present disclosure. The engine 10 may comprise a housing 12 defining a plurality of cylinders 14, a plurality of high pressure direct injectors (HPDIs) 16, and pistons 18 which move in reciprocating fashion within the cylinders 14. The housing 12 may define any number of cylinders 14, such as but not limited to six or eight cylinders 14. Each HPDI 16 is operably mounted to one of the cylinders 14 and controls the amount of fuel, either diesel or natural gas, that is injected into the cylinder 14. Fuel that is burned in the cylinders 14 exits the engine 10 through an exhaust outlet (not shown).

The engine 10 further comprises an engine compression brake 20 operably connected to each cylinder 14. Each engine compression brake 20 is electronically controlled by an actuator 22 which in turn is controlled by an electronic control module (ECM) 24, as are the HPDIs 16.

Each electronically controlled HPDI 16 is operably attached to a cylinder 14. The HPDIs 16 are configured to deliver diesel fuel and natural gas to the cylinder 14.

The system further comprises a sensor (not shown) for sensing the temperature of the engine 10. The sensor may be adapted to sense engine coolant temperature, engine exhaust temperature or any other suitable temperature.

The ECM 24 is in control communication with each HPDI 16. The ECM 24 includes a rapid warm-up mode in which the HPDIs 16 for a first portion of the cylinders 14 are activated (in “power mode”) and the engine compression brakes 20 for a second portion of the cylinders are activated putting the second portion of cylinders 14 in “braking mode”. These modes, power or braking, may be maintained for one or more cycles.

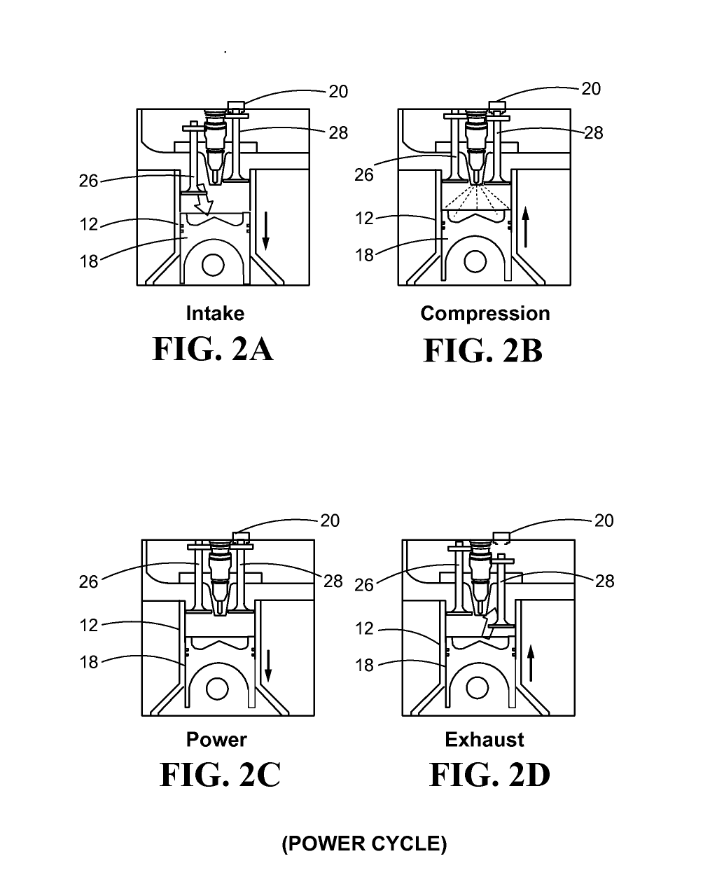

FIGS. 2A to 2D are schematic diagrams of an engine cylinder 14 during a four stroke power cycle. In a typical four-stroke diesel engine, for each cylinder 14 in power mode, air is introduced into the cylinder 14 during an intake stroke as the piston 18 moves downward, away from the cylinder head, while an air intake valve 26 is in the open position (FIG. 2A). As the piston 18 reverses direction and moves upward, the air is compressed in the cylinder 14, which superheats the air. At or near the point of greatest compression diesel fuel is introduced into the superheated air and immediately begins burning (FIG. 2B). The rapid fuel combustion pushes the piston 18 downward, powering the machine (FIG. 2C). After this power stroke, the piston 18 again moves upward, this time while the exhaust gas valve 28 is open, forcing out the exhaust gases (FIG. 2D).

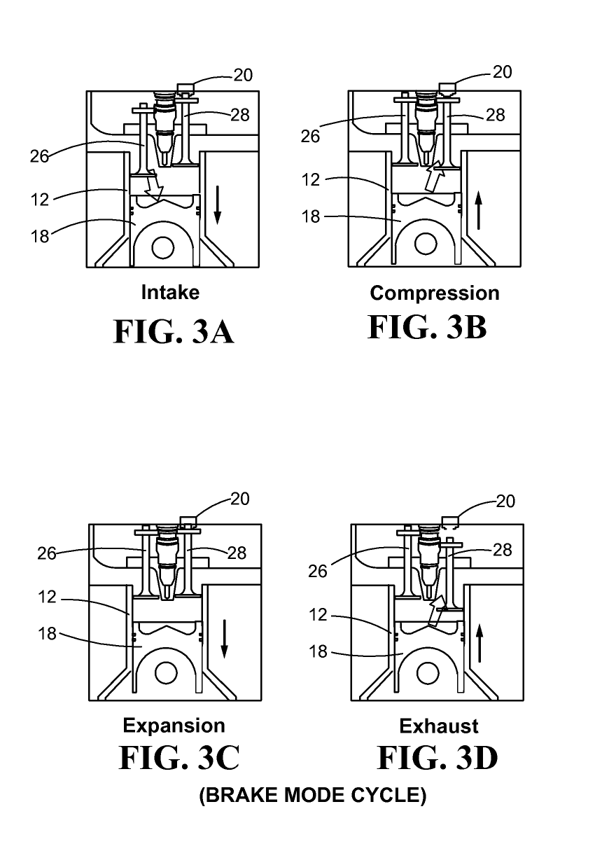

FIGS. 3A to 3D are schematic diagrams of an engine cylinder 14 during a four stroke braking cycle. When the engine 10 of FIG. 1 is in rapid warm-up mode, no fuel is injected into that portion of the cylinders 14 in braking mode. Rather, those cylinders 14 in braking mode act as air compressors to slow down the vehicle. This is accomplished as follows: For those cylinders 14 in braking mode, air only is introduced into the cylinder 14 during the intake stroke (FIG. 3A). The air is compressed to a very high pressure during the compression stroke, but there is no fuel in the cylinder 14 to be ignited. As the air pressure increases, the temperature of the air also increases. At the top of the compression stroke the engine compression brake 20 opens the exhaust valve, allowing the hot compressed air to exit through the exhaust outlet (FIG. 3B). The cylinder moves away from the injector during an expansion stroke and therefore draws power from the engine (FIG. 3C). Finally, the cylinder 14 moves upward during an exhaust stroke, while once again the engine compression brake 20 opens the exhaust valve, allowing any remaining hot air to exit through the exhaust outlet (FIG. 3D). The parasitic load imposed on the engine 10 by the cylinders 14 in braking mode creates hot air that warms the engine 10 but does not use up fuel. In addition, the additional fuel required by the cylinders 14 in power mode to overcome the parasitic load from the cylinders 14 in braking mode also helps warm the engine 10. In summary, the combination of hot air generated by the cylinders in braking mode and the additional fuel consumption by the cylinders in power mode shortens the engine warm-up time.

Thus the present disclosure relates to a system of utilizing engine compression braking technology not to slow down a vehicle, but to shorten engine warm-up time during initial idling or cold weather idling by putting some of the engine cylinders 14 in braking mode while others remain in power mode. Rather than firing every cylinder 14 at the end of every air compression stroke, engine compression technology is used to alternate between power mode and braking mode in each cylinder 14 (a process known as “skip firing”), or by powering some cylinders 14 and not others. If every cylinder 14 is equipped with engine braking technology, the operator can fire that cylinder 14 with diesel fuel during one cycle and then operate the same cylinder 14 in braking mode during the next cycle. The power cylinders 14 may require additional fuel to compensate for the braking occurring in the other cylinders 14. By moving the braking cylinders 14 around, i.e., changing which cylinders 14 operate in braking mode, the system assures that every cylinder 14 generates “braking” heat for the exhaust gases. The braking heat from the braking cylinders plus the extra load on the power cylinders is then used to warm up the engine 10 (and the LNG) more quickly than in normal start-up mode.

Alternatively, a conventional exhaust brake can be used to increase parasitic load and thus reduce engine warm-up time. In a conventional exhaust brake system a valve is used to restrict the flow of exhaust gases out the engine, creating back pressure which slows the engine.

Preferably high pressure direct injectors 16 with DoM capability can be applied to provide adequate fueling to the powered cylinders 14 to compensate for the parasitic, braking mode, cylinders 14. The combined effect of high fueling in some cylinders 14 and high parasitic loading in other cylinders 14 results in a rapid warm-up after initial starting.

The system may be an automated system which senses various engine temperatures to determine when the technology would be beneficial to decrease warm-up time.

In another aspect the present disclosure relates to a rapid warm-up system having an electronically controlled delivery system operably attached to each cylinder, wherein the delivery system is configured to deliver diesel fuel and natural gas to the cylinders. The delivery system may deliver high to medium pressure supercritical natural gas or low pressure natural gas to the cylinders via in-cylinder injection, port injection or fumigation into an air stream. Regardless of the NG delivery system, a natural gas/air mixture is ignited via the compression ignition of diesel fuel that has been injected into the cylinders.

In all of these systems, whether the NG is high pressure direct injected or port injected, the LNG must be warmed up from a cryogenic fluid state to a gaseous state before the NG is introduced into the cylinders. If there is not enough heat from the engine to quickly warm up the LNG, the engine compression braking technology can be used to add a parasitic load to more quickly warm up the engine

### The Method

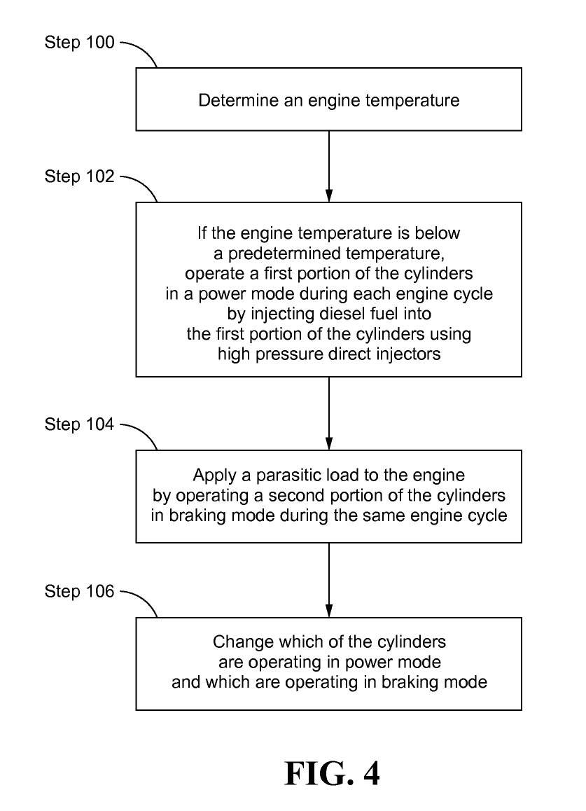

The present disclosure also relates to a method of utilizing engine compression braking technology to shorten engine warm-up time. The method works by creating a parasitic load on the engine during initial idling by putting some of the engine cylinders in braking mode while others remain in power mode. FIG. 4 is a schematic diagram of a process for rapid engine warm-up according to the present disclosure. The method may comprise the following steps:

Step 100: Determining an engine temperature. This step may include using a sensor to determine engine coolant temperature, engine exhaust temperature, engine oil temperature or some other suitable engine temperature.

Step 102: If the engine temperature is below a predetermined temperature, operating a first portion of the cylinders 14 in a power mode during each engine cycle. This step may include injecting diesel fuel into the first portion of the cylinders 14 using HPDIs 16. An ECM in control communication with each HPDI 16 includes a rapid warm-up mode in which the HPDIs 16 for the first portion of the cylinders 14 are activated, thereby placing the cylinders in power mode.

Step 104: Applying a parasitic load to the engine 10. This step may include operating a second portion of the cylinders 14 in braking mode during the same engine cycle. This step may be done simultaneously with step 102. Again, an ECM in control communication with each HPDI 16 includes a rapid warm-up mode in which the engine compression brakes 20 for the second portion of the cylinders 14 are activated, thereby placing those cylinders 14 in braking mode.

The method may include the additional step of:

Step 106: Changing which of the cylinders 14 are operating in power mode and which cylinders 14 are operating in braking mode. The operating mode of every cylinder 14 can be changed with each engine cycle or after a given number of engine cycles. Alternatively, instead of changing the operating mode of every cylinder 14 at the same time, the operating mode can be changed on a rolling basis, so that with each cycle or after a given number of cycles the operating mode of some cylinders 14 change while the operating mode of other do not.

The rapid warm-up mode just described preferably is activated by the ECM. The ECM may be used to detect when the engine temperature is below a predetermined value, the engine throttle is in the idle position, and the engine transmission is not in gear, as requisite conditions for placing the engine 10 in rapid warm-up mode.

### INDUSTRIAL APPLICABILITY

The system and method of the present disclosure may be used whenever rapid warm-up is desired to reduce diesel fuel consumption (and costs) by more quickly substituting diesel fuel with natural gas. The technology can be used with mining trucks, locomotives and in any engine applications utilizing dual fuel LNG—diesel fuel systems.

It is understood that the embodiments of the disclosure described above are only particular examples which serve to illustrate the principles of the disclosure. Modifications and alternative embodiments of the disclosure are contemplated which do not depart from the scope of the disclosure as defined by the foregoing teachings and appended claims. It is intended that the claims cover all such modifications and alternative embodiments that fall within their scope.

I claim:

1. A system for rapidly warming up a dual fuel engine, the system comprising:
a plurality of cylinders;
at least one electronically controlled high pressure direct injector operably attached to each cylinder, the at least one high pressure direct injector configured to deliver diesel fuel and natural gas to the cylinder;
an electronically controlled engine compression brake operably attached to at least one of the cylinders;
a sensor for sensing a temperature of the engine; and
an electronic control module in control communication with each high pressure direct injector, the electronic control module including a rapid warm-up mode in which the high pressure direct injectors for a first portion of the cylinders are activated and the engine compression brakes for a second portion of the cylinders are activated.

2. The system of claim 1 wherein:
the sensor is adapted to sense engine coolant temperature.

3. The system of claim 1 wherein:
the sensor is adapted to sense engine exhaust temperature.

4. The system of claim 1 wherein:
the sensor is adapted to sense engine oil temperature.

5. The system of claim 1 wherein:
the first portion of the cylinders and the second portion of the cylinders equals the plurality of cylinders.

6. The system of claim 1 wherein:
an electronically controlled engine compression brake is operably attached to each of the cylinders.

7. The system of claim 1 wherein:
the high pressure direct injectors are configured to deliver additional diesel fuel to the first portion of the cylinders during rapid warm-up mode.

8. The system of claim 1 wherein:
the first portion of the cylinders is designated power cylinders;
the second portion of the cylinders is designated braking cylinders; and
the power cylinders change to braking cylinders and the braking cylinders change to power cylinders after a given number of engine cycles.

9. The system of claim 8 wherein:
the given number of engine cycles is one.

10. A method for rapidly warming up a dual fuel engine having a plurality of cylinders, the method comprising the steps of:
Step 100: determining an engine temperature;
Step 102: if the engine temperature is below a predetermined temperature, operating a first portion of the cylinders in a power mode during each engine cycle; and
Step 104: applying a parasitic load to the engine.

11. The method of claim 10 wherein:
Step 102 includes injecting diesel fuel into the first portion of the cylinders using high pressure direct injectors.

12. The method of claim 11 wherein:
Step 104 includes operating a second portion of the cylinders in braking mode during the same engine cycle.

13. The method of claim 12 wherein:
Step 100 includes determining engine coolant temperature.

14. The method of claim 12 wherein:
Step 100 includes determining engine exhaust temperature.

15. The method of claim 12 wherein:
Step 100 includes determining engine oil temperature.

16. The method of claim 12 including the step of:
Step 106: changing which of the cylinders are operating in power mode and which cylinders are operating in braking mode.

17. The method of claim 16 wherein:
Step 106 includes changing the operating mode of every cylinder after a given number of engine cycles.

18. The method of claim 13 wherein:
Step 106 includes changing the operating mode of every cylinder after each engine cycle.

19. The method of claim 13 wherein:
Step 106 includes changing the operating mode of the cylinders on a rolling basis, so that after a given number of cycles the operating mode of some cylinders change while the operating mode of other cylinders do not.

20. A system for rapidly warming up a dual fuel engine, the system comprising:
a plurality of cylinders;
an electronically controlled delivery system operably attached to each cylinder, the delivery system configured to deliver diesel fuel and natural gas to each cylinder;
an electronically controlled engine compression brake operably attached to at least one of the cylinders;
a sensor for sensing a temperature of the engine; and
an electronic control module in control communication with each delivery system, the electronic control module including a rapid warm-up mode in which the delivery system for a first portion of the cylinders are activated and the engine compression brakes for a second portion of the cylinders are activated.

21. The system of claim 20 wherein:
the delivery system is configured to deliver natural gas to the cylinders via in-cylinder injection.

22. The system of claim 20 wherein:
the delivery system is configured to deliver natural gas to the cylinders via port injection.

23. The system of claim 20 wherein:
the delivery system is configured to deliver natural gas to the cylinders via fumigation into an air stream.
